(19) United States
(12) Patent Application Publication
(10) Pub. No.: US 2011/0085782 A1
(43) Pub. Date: Apr. 14, 2011

(54) METHOD FOR SYNCHRONIZING AUDIO DATA WITH SECONDARY DATA

(76) Inventor: Ozymandias Wong, Shenzhen (HK)

(21) Appl. No.: 12/578,733

(22) Filed: Oct. 14, 2009

(51) Int. Cl. H04N 5/91; H04N 5/932; H04N 5/935

(52) U.S. Cl. 386/338; 386/E05.037; 386/201

(57) ABSTRACT

Disclosed is a method for synchronizing audio data with secondary data. The method includes the step of providing indexes of events corresponding to frames in an audio stream, the step of relating the secondary data to the indexes of the events, the step of checking the indexes of the events to determine whether an event of interest is reached or not, and the step of playing some of the secondary data corresponding to the event of interest if the event of interest is reached.

### BACKGROUND OF THE INVENTION

1. Field of the Invention

The present invention relates to multimedia and, more particularly, to a method for synchronizing audio data with secondary data in multimedia.

2. Related Prior Art

In a conventional synchronization technique often used in a MP3 Lyrics or Karaoke system, an additional time-based data file is used to assign texts to audio data referring to FIG. 1. Points of time for the texts are stored in the time-based data file. Thus, the texts are synchronized with the audio data according to a timeline. However, if it is desired to play the audio data faster, points of time in the time-based data file must be calculated all over again before the synchronization can be executed.

In another conventional technique for synchronizing audio data with video data, audio features are extracted when the audio data are played. Based on the audio features, the video data are played. For instance, the maximum wave slope is used to synchronize the video data with the audio data. It is however difficult to extract the audio features and the synchronization of the audio data with the video data is not precise.

There are few open audio book standards available in the market and developers are not willing to follow these definitions. As a result, different multimedia applications develop their own ways to handle synchronization. This makes development more time-consuming and error-prone.

The present invention is therefore intended to obviate or at least alleviate the problems encountered in prior art.

### SUMMARY OF THE INVENTION

It is an objective of the present invention to provide an efficient and reliable method for synchronizing audio data with secondary data.

To achieve the foregoing objective, the method includes the step of providing indexes of events corresponding to frames in an audio stream, the step of relating the secondary data to the indexes of the events, the step of checking the indexes of the events to determine whether an event of interest is reached or not, and the step of playing some of the secondary data corresponding to the event of interest if the event of interest is reached.

It is another objective of the present invention to provide a multimedia player.

To achieve the foregoing objective, the multimedia player includes an audio storage unit, a secondary data storage unit and a playing unit. The audio storage unit stores audio data. The secondary data storage unit stores a pointer and a custom file of secondary data. The playing unit plays the audio data stored in the audio storage unit, determines whether an event of interest is reached or not, and searches the secondary data storage data for a segment of the secondary data corresponding to the event of interest, and plays the segment of the secondary data if the event of interest is reached.

It is another objective of the present invention to provide a multimedia data-providing device.

To achieve the foregoing objective, the multimedia data-providing device includes an audio recording unit, a secondary data unit and a storage unit. The audio recording unit transforms sound to audio data, and records the audio data. The secondary data unit provides a pointer and a custom file of audio data, determines positions for the secondary data to emerge, and provides indexes for relating segments of the secondary data to the events based on frames of an audio stream while the audio recording unit records the audio data. The storage unit stores the audio data and the secondary data in different channels.

Other objectives, advantages and features of the present invention will be apparent from the following description referring to the drawings.

### BRIEF DESCRIPTION OF THE DRAWINGS

The present invention will be described via detailed illustration of embodiments referring to the drawings.

FIG. 1 shows audio data on a timeline.

FIG. 2 is a flowchart of a method for synchronizing audio data with secondary data according to the present invention.

FIG. 3 shows two frames in an audio stream corresponding to two events.

FIG. 4 shows two segments of the secondary data corresponding to the events shown in FIG. 3.

FIG. 5 shows a file of secondary data.

FIG. 6 shows lengths of segments of secondary data corresponding to the events shown in FIG. 3 so that secondary data in the file shown in FIG. 5 can be synchronized with the audio data.

FIG. 7 is a block diagram of a multimedia player according to another embodiment of the present invention.

FIG. 8 is a block diagram of a multimedia data-providing device according to another embodiment of the present invention.

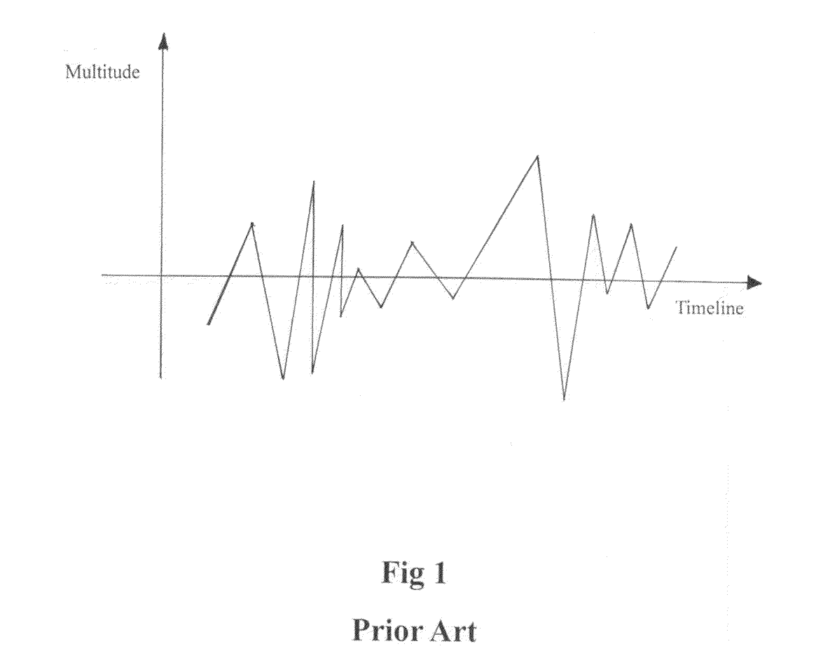

### DETAILED DESCRIPTION OF THE INVENTION

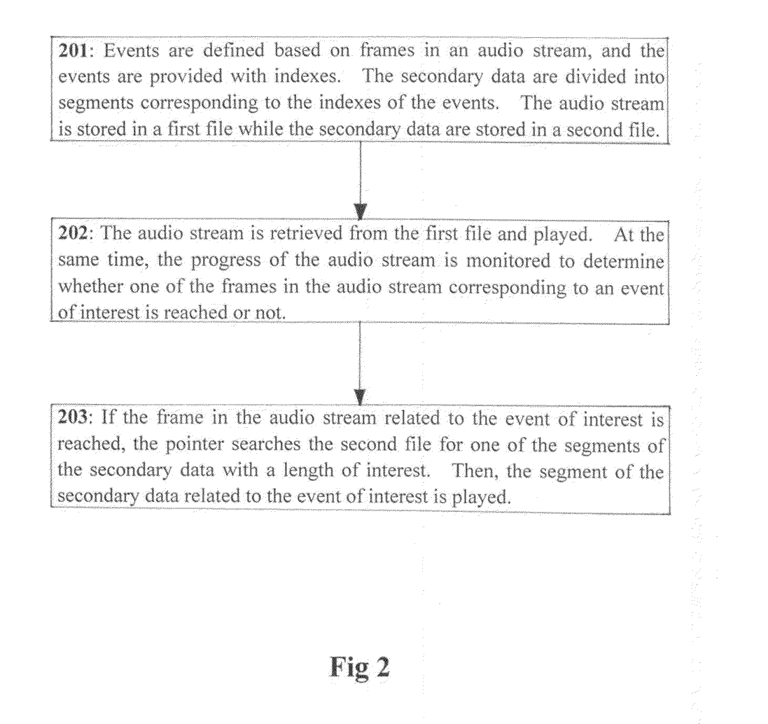

Referring to FIGS. 2 to 4, there is shown a method for synchronizing primary data with secondary data according to a first embodiment of the present invention. The primary data are audio data. The secondary data include video data and/or audio data. The video data include texts, images and/or video footages. At 201, events are defined based on frames in an audio stream, and the events are provided with indexes. The secondary data are divided into segments corresponding to the indexes of the events. The audio stream is stored in a first file while the secondary data are stored in a second file.

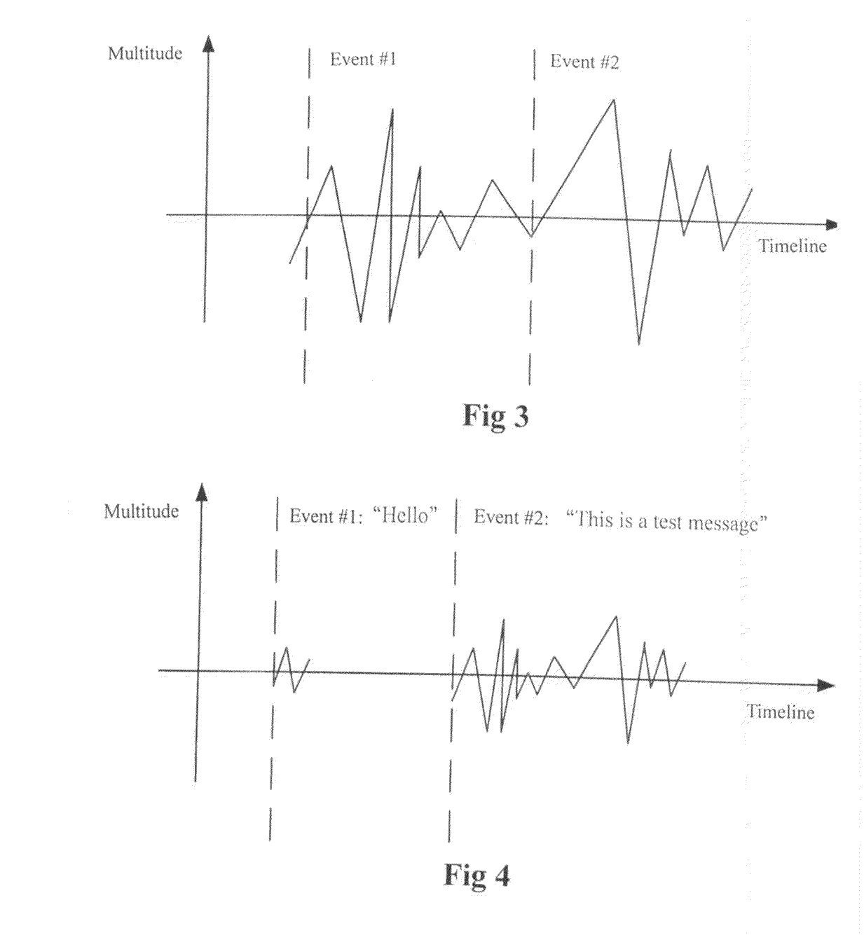

As clearly shown in FIG. 3, there are defined two events #1 and #2 for example. The audio data includes two segments corresponding to events #1 and #2.

At 202, the audio stream is retrieved from the first file and played. At the same time, the progress of the audio stream is monitored to determine whether one of the frames in the audio stream corresponding to an event of interest is reached or not.

At 203, the second file is searched for a segment of the secondary data corresponding to the event of interest if the frame in the audio stream related to the event of interest is reached. Then, the segment of the secondary data is played.

As discussed above, when the audio stream is played, the secondary data are also played. The secondary data are directly linked to the audio data, not through another factor such as a timeline. Therefore, the synchronization of the audio data with the secondary data is precise.

Moreover, the secondary data can be changed independent of the audio data. Therefore, the method of the present invention is useful in multimedia applications and, more particularly, in electronic books.

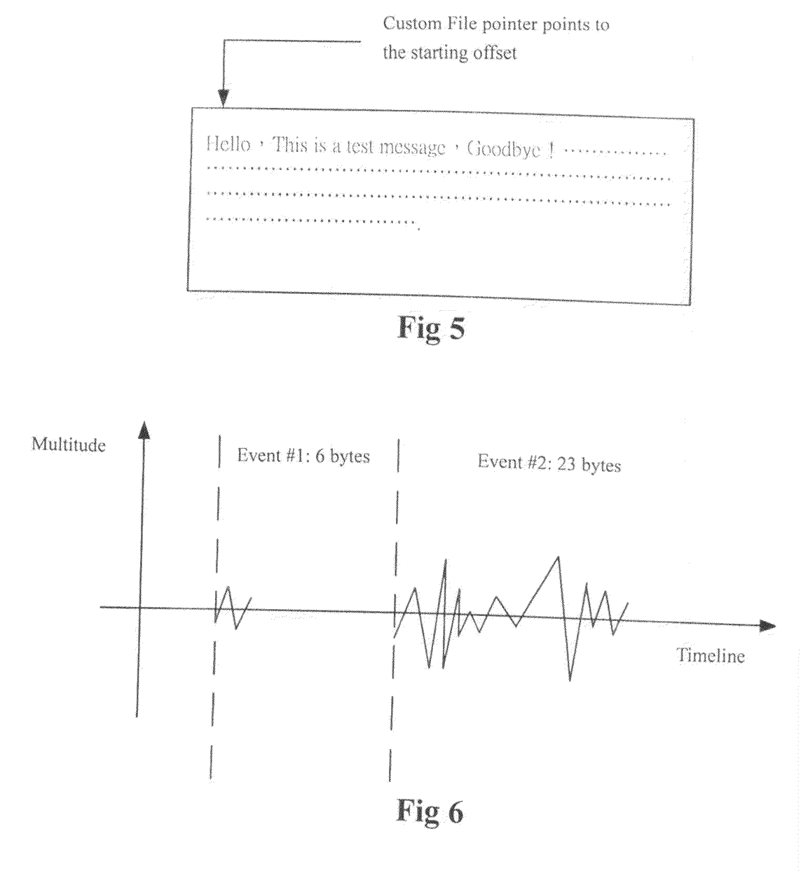

Referring to FIGS. 2, 3, 5 and 6, there is shown a method for synchronizing audio data with secondary data according to a second embodiment of the present invention. At 201, events are defined based on frames in an audio stream, and the events are provided with indexes. A pointer is provided to search for segments of the secondary data corresponding to the events. The audio stream is stored in a first file. The secondary data are stored in a second file (or “custom filed”). The pointer includes the length of a segment of the secondary data related to each event.

As clearly shown in FIG. 3, there are defined two events #1 and #2 for example. The length of a segment of the secondary data corresponding to event #1 “Hello.” is 6 bytes, and the length of another segment of the secondary data related to event #2 “This is a test message, Goodbye!” is 23 bytes.

At 202, the audio stream is retrieved from the first file and played. At the same time, the progress of the audio stream is monitored to determine whether one of the frames in the audio stream corresponding to an event of interest is reached or not.

At 203, if the frame in the audio stream related to the event of interest is reached, the pointer searches the second file for one of the segments of the secondary data with a length of interest. Then, the segment of the secondary data related to the event of interest is played.

For example, if the frame in the audio stream related to event #1 is reached, the pointer searches the second file for one of the segments of the secondary data with a length of 6 bytes, i.e., “Hello.” Then, the segment of the secondary data related to event #1, “Hello.” is played. If the frame in the audio stream related to event #2 is reached, the pointer searches the second file for one of the segments of the secondary data with a length of 23 bytes, i.e., “This is a test message, Goodbye!” Then, the segment of the secondary data related to event #2 “This is a test message, Goodbye!” is played. The audio data and the secondary data are played in different channels.

The second embodiment of the present invention exhibits a unique advantageous feature that the audio data and the secondary data are played in different channels. A developer can provide the custom file in many ways without having to worry about the format of the audio data. Hence, the synchronization is efficient and inexpensive.

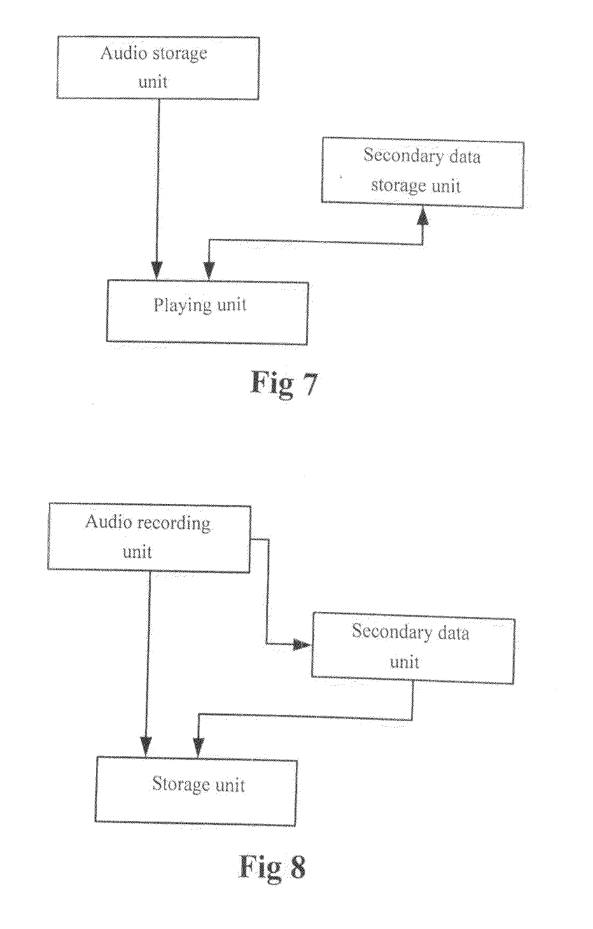

Referring to FIG. 7, there is shown a multimedia player according to a third embodiment of the present invention. The multimedia player includes an audio storage unit, a secondary data storage unit and a playing unit. The audio storage unit stores audio data. The secondary data storage unit stores a pointer and a custom file of secondary data. The playing unit plays the audio data stored in the audio storage unit, and determines whether an event of interest is reached or not. If so, the playing unit searches the secondary data storage data for a segment of the secondary data related to the event of interest, and plays the segment of the secondary data. The audio storage unit can be combined with the secondary data storage unit. That is, the multimedia player can include a single storage unit for storing the audio data, the custom file and the pointer independent of one another.

Referring to FIG. 8, there is shown a multimedia data-providing device according to a fourth embodiment of the present invention. The multimedia player includes an audio recording unit, a secondary data unit and a storage unit. The audio recording unit transforms sound to audio data, and records the audio data. The secondary data unit is used to provide a pointer and a custom file of audio data. When the audio recording unit records the audio data, the secondary data unit determines positions for the secondary data to emerge, and provide indexes for relating segments of the secondary data to events based on frames of an audio stream. The secondary data are stored independent of the audio data. That is, the indexes do not have to be added to the audio stream. The storage unit stores the audio data and the secondary data in different channels.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for synchronizing audio data with secondary data comprising the steps of:
providing indexes of events corresponding to frames in an audio stream;
relating the secondary data to the indexes of the events;
checking the indexes of the events to determine whether an event of interest is reached or not; and
playing a segment of the secondary data corresponding to the event of interest if the event of interest is reached.

2. The method according to claim 1, wherein the secondary data are selected from a group consisting of texts, images and video footages.

3. The method according to claim 1, wherein the step of relating the secondary data to the indexes of the events comprises the steps of:
dividing the secondary data into segments corresponding to the indexes of the events; and
indexing the segments of the secondary data.

4. The method according to claim 1, wherein the step of relating the secondary data to the indexes of the events comprises the steps of:
providing a custom file for the secondary data; and
providing a pointer for searching the custom file for some of the secondary data corresponding to the event of interest.

5. The method according to claim 4, wherein the pointer comprises:
the indexes and the events; and
lengths of segments of the secondary data corresponding to the indexes of invents.

6. A multimedia player comprising:
an audio storage unit for storing audio data;
a secondary data storage unit for storing a pointer and a custom file of secondary data; and
a playing unit for playing the audio data stored in the audio storage unit, determining whether an event of interest is reached or not, and searching the secondary data storage data for a segment of the secondary data corresponding to the event of interest and playing the segment of the secondary data if the event of interest is reached.

7. The multimedia player according to claim 6, wherein the secondary data are selected from a group consisting of texts, images and video footages.

8. A multimedia data-providing device comprising:
an audio recording unit for transforming sound to audio data, and recording the audio data;
a secondary data unit for providing a pointer and a custom file of audio data, determining positions for the secondary data to emerge and providing indexes for relating segments of the secondary data to the events based on frames of an audio stream while the audio recording unit records the audio data; and
a storage unit for storing the audio data and the secondary data in different channels.

9. The multimedia data-providing device according to claim 8, wherein the secondary data are selected from a group consisting of texts, images and video footages.
